(19) United States
(12) Patent Application Publication
(10) Pub. No.: US 2003/0034382 A1
(43) Pub. Date: Feb. 20, 2003

(54) Solder sheet with a bump grid array, process for manufacturing the solder sheet, and process for producing an electronic device using the sholder sheet

(76) Inventor: Chen-Chi Huang, Kaohsiung Hsien (TW)

Correspondence Address: WEBB ZIESENHEIM LOGSDON, ORKIN & HANSON, P.C., 700 Koppers Building, 436 Seventh Avenue, Pittsburgh, PA, 15219-1818, US

(21) Appl. No.: 09/933,028

(22) Filed: Aug. 20, 2001

(51) Int. Cl. B23K 35/12; B23K 35/14

(52) U.S. Cl. 228/246; 228/56.3

(57) ABSTRACT

A process for producing a solder sheet with a bump grid array includes the step of molding a sheet of solder material in a mold having two mold halves. Each of the mold halves is formed with an array of first recesses. At least one of the mold halves is further formed with a plurality of second recesses interconnecting adjacent pairs of the first recesses. Each of the first recesses has a depth deeper than that of the second recesses. The first recesses of one of the mold halves are registered with the first recesses of the other of the mold halves such that the first and second recesses of the mold halves cooperatively form a mold cavity defining the shape of the molded solder sheet when the mold halves are brought toward each other to close the mold.

### BACKGROUND OF THE INVENTION

1. Field of the Invention

The invention relates to a solder sheet, more particularly to a solder sheet with a bump grid array. This invention additionally relates to a process for manufacturing the solder sheet, and a process for producing an electronic device that uses the solder sheet.

2. Description of the Related Art

FIG. 1 illustrates a conventional apparatus 1 for producing solder bumps which are to be arranged in a ball grid array for application to the surface mounting package of an electronic device. Molten solder material 15 in a vessel 11 will not leak through a nozzle 111 during an initial heating period by virtue of the surface tension thereof. When the molten solder material 15 is heated over a critical temperature, a magnetic membrane 14 driven by a high vibrating frequency generator 13 will vibrate and create stress intermittently acting on the molten solder material 15, thereby pressing the molten solder material 15 out of the vessel 11 through the nozzle 111 to create molten solder bumps 18. The molten solder bumps 18 are cooled in a cooling device 16 so as to form solid solder bumps 17.

However, referring to FIG. 2, due to the effect of various parameters, such as viscosity, surface tension and jet velocity of the molten solder material 15, uniform size and shape of the solder bumps can hardly be achieved. Furthermore, since the configuration of the solder bumps 17 is controlled by the aforementioned parameters, repeated tests are required in order to obtain proper parameters for producing the desired solder bumps. Additionally, a sieving step is required to remove irregular solder bumps. Use of the conventional apparatus thus results in low production yield and in a time-consuming packaging process.

### SUMMARY OF THE INVENTION

Therefore, the object of the present invention is to provide a solder sheet with a bump grid array that can be produced without the use of the aforesaid conventional apparatus so as to overcome the aforesaid drawbacks of the prior art. Another object of the present invention is to provide a method for manufacturing the solder sheet. Yet another object of the present invention is to provide a method for producing an electronic device that uses the solder sheet.

According to one aspect of the present invention, a solder sheet comprises a grid array of solder bumps and a plurality of links interconnecting and integrally formed with the solder bumps from a solder material by a molding process. Each of the links has a thickness smaller than those of the solder bumps.

According to another aspect of the present invention, a process for manufacturing a solder sheet comprises the steps of: preparing a sheet of solder material; preparing a mold which has two mold halves, each of the mold halves being formed with an array of first recesses, at least one of the mold halves being further formed with a plurality of second recesses respectively interconnecting adjacent pairs of the first recesses, each of the first recesses having a depth deeper than that of the second recesses, the first recesses of one of the mold halves registering with the first recesses of the other of the mold halves such that the first and second recesses of the mold halves cooperatively form a mold cavity when the mold halves are brought toward each other to close the mold; and disposing the sheet between the mold halves, and molding the sheet into a shape defined by the mold cavity.

According to yet another aspect of the present invention, a process for producing an electronic devices comprises the steps of: preparing a sheet of solder material; preparing a mold which has two mold halves, each of the mold halves being formed with an array of first recesses, and a frame recess surrounding outermost ones of the first recesses of the array, at least one of the mold halves being further formed with a plurality of second recesses interconnecting adjacent pairs of the first recesses, each of the first recesses having a depth deeper than that of the second recesses, the first recesses of one of the mold halves registering with the first recesses of the other of the mold halves such that the first and second recesses of the mold halves cooperatively form a mold cavity when the mold halves are brought toward each other to close the mold; disposing the sheet between the mold halves, and molding the sheet into a shape defined by the mold cavity so as to produce a molded solder sheet, which includes a grid array of solder bumps, a plurality of links interconnecting the solder bumps, a plurality of connecting portions connected to and extending between adjacent ones of the solder bumps and the links, and a frame surrounding outermost ones of the solder bumps of the grid array and connected to outermost ones of the connecting portions, each of the links having a thickness smaller than those of the solder bumps; preparing a substrate with circuits thereon; attaching the molded solder sheet to the substrate; separating the frame, the links, and the connecting portions from the solder bumps by peeling; and welding the solder bumps onto the substrate; whereby the solder bumps serve as contact terminals for the circuits on the substrate.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional apparatus for producing solder bumps;

FIG. 2 is a schematic view showing various configurations of solder bumps produced by the apparatus of FIG. 1 at different jet velocities;

FIG. 3 is a flow diagram of a first preferred embodiment of a process for manufacturing a solder sheet according to this invention;

FIG. 4 is a perspective view of a sheet of solder material and a mold according to the process of this invention;

FIG. 5 is a sectional view of a mold used in the process of the first preferred embodiment;

FIG. 6 is a fragmentary sectional view of the first preferred embodiment of a solder sheet according to this invention;

FIG. 7 is a perspective view of the first preferred embodiment of a solder sheet according to this invention;

FIG. 8 is a sectional view of a mold used in the second preferred embodiment of a manufacturing process according to this invention;

FIG. 9 is a fragmentary sectional view of the second preferred embodiment of a solder sheet according to this invention; and

FIG. 10 is a schematic view showing an electronic device that utilizes the solder sheet of this invention.

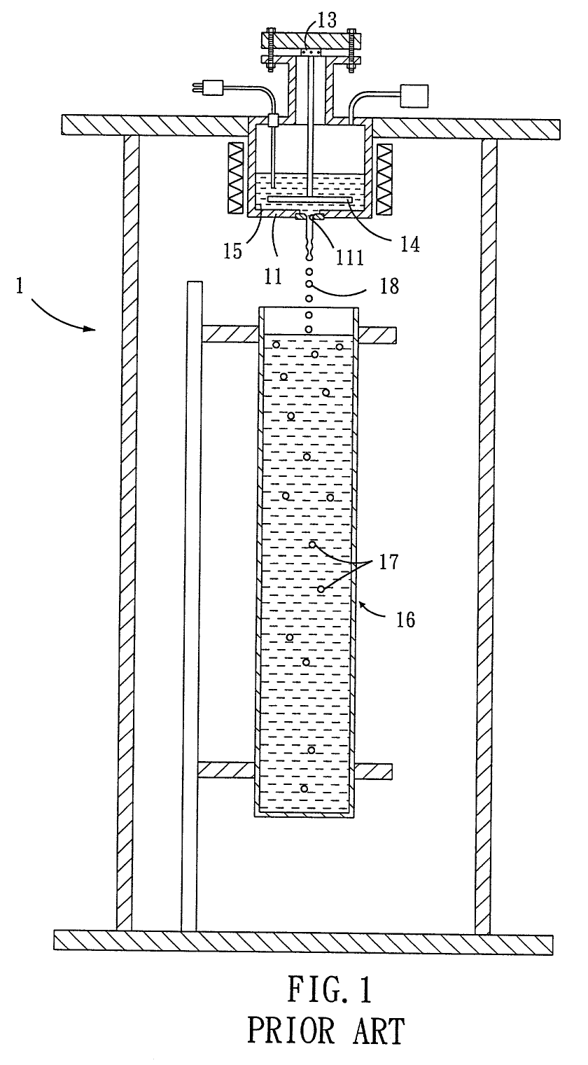

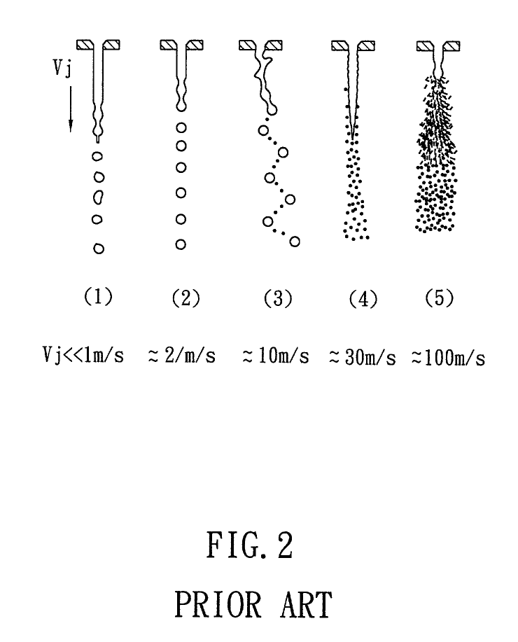

### DETAILED DESCRIPTION OF THE PREFERRED EMBODIMENTS

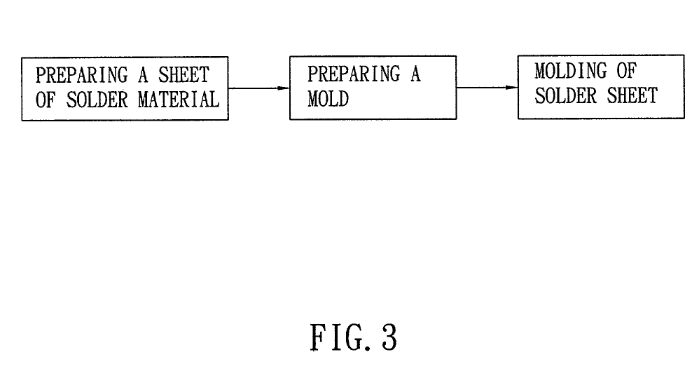

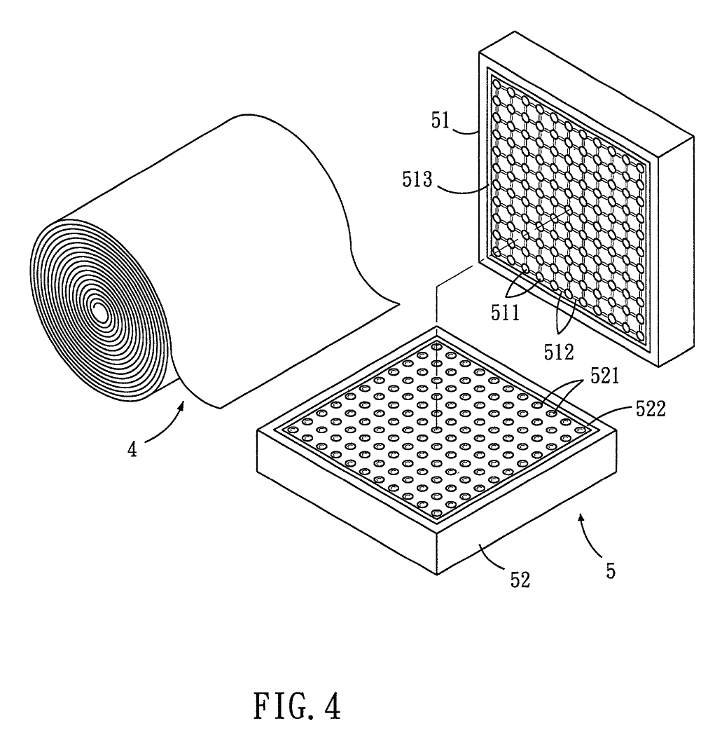

Referring to FIGS. 3 and 4, the preferred embodiment of the process for manufacturing a solder sheet according to this invention comprises the steps of:

(1). Preparing a Sheet 4 of Solder material:

A sheet 4 of solder material is prepared for use in the following molding step.

(2). Preparing a Mold 5 for Molding the Sheet 4 of Solder Material:

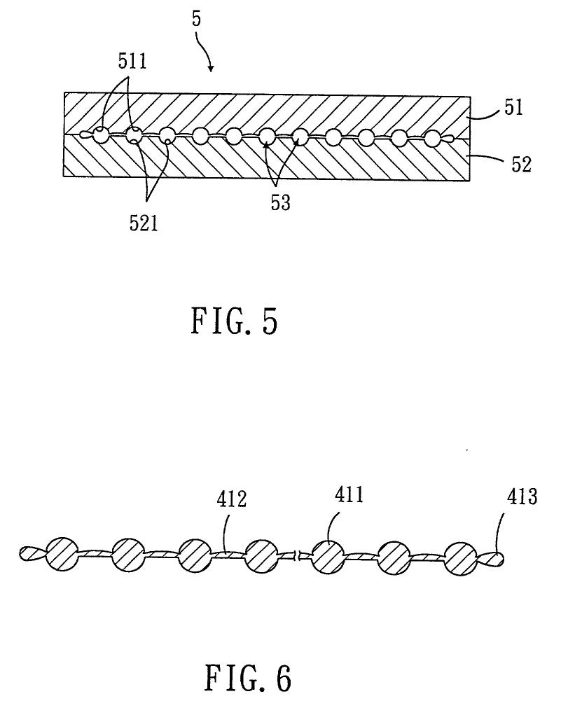

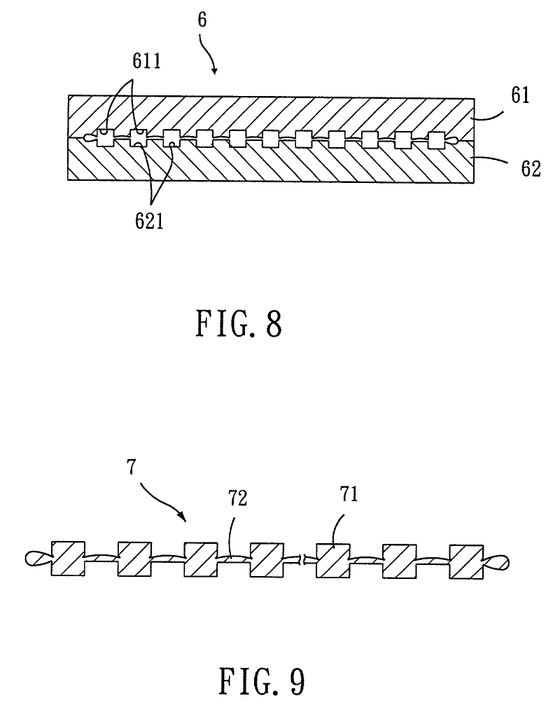

The mold 5 includes a top mold half 51 and a bottom mold half 52. Each of the top and bottom mold halves 51, 52 is formed with an array of first recesses 511, 521. The top mold half 51 is further formed with a plurality of second recesses 512 interconnecting adjacent pairs of the first recesses 511. Each of the first recesses 511 has a depth deeper than that of the second recesses 512. Each of the second recesses 512 increases gradually in depth from an adjacent connected one of the first recesses 511 to a center thereof. Additionally, each of the top and bottom mold halves 51, 52 is formed with a frame recess 513, 522. Each of the frame recesses 513, 522 surrounds outermost ones of the first recesses 511, 521 of the array. The shape of each of the first recesses 511, 521 could be any shape appropriate for use in this invention. FIG. 5 illustrates the sectional view of the mold 5 used in the process of the first preferred embodiment. Each of the first recesses 511, 521 is semi-spherical in shape. As shown in FIG. 8, each of the first recesses 611, 621 of the top and bottom mold halves 61, 62 of the mold 6 used in the process of the second preferred embodiment of this invention is rectangular in shape.

(3). Molding of the Solder Sheet:

The sheet 4 of solder material is disposed between the top and bottom mold halves 51, 52. The top and bottom mold halves 51, 52 are then brought toward each other to close the mold 5. The first recesses 511 of the top mold half 51 are registered with the first recesses 521 of the bottom mold half 52 such that the first and second recesses 511, 521, 512 of the top and bottom mold halves 51,52 cooperatively form a mold cavity 53, as shown in FIG. 5. The sheet 4 of solder material is then molded into a shape defined by the mold cavity 53. Any appropriate pressing process well known in the art can be applied to mold the sheet 4 of solder material.

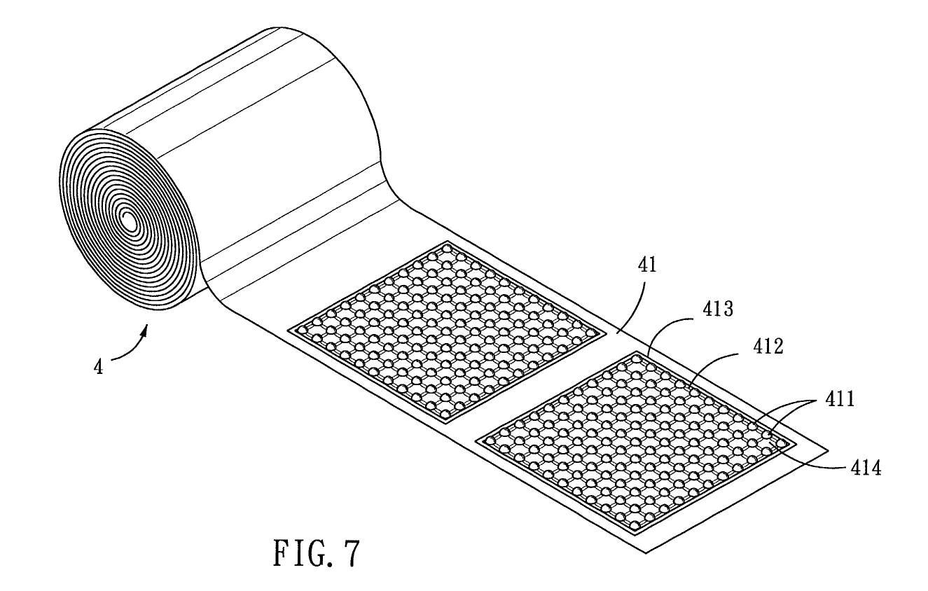

Referring to FIGS. 6 and 7, the solder sheet 41 thus formed includes a grid array of solder bumps 411, a plurality of links 412 interconnecting the solder bumps 411, a plurality of connecting portions 414 connected to and extending between adjacent ones of the solder bumps 411 and the links 412, and a frame 413 surrounding outermost ones of the solder bumps 411 of the grid array and connected to outermost ones of the connecting portions 414. Each of the links 412 has a thickness smaller than those of the solder bumps 411. Furthermore, each of the links 412 has a thickness profile which increases gradually from an adjacent connected one of the solder bumps 411 to a center thereof. As shown in FIG. 6, each of the solder bumps 411 of the solder sheet 41 of the first preferred embodiment is spherical in shape. Referring to FIG. 9, each of the solder bumps 71 of the solder sheet 7 obtained with the use of the mold 6 of FIG. 8 in the process of the second preferred embodiment is rectangular in shape.

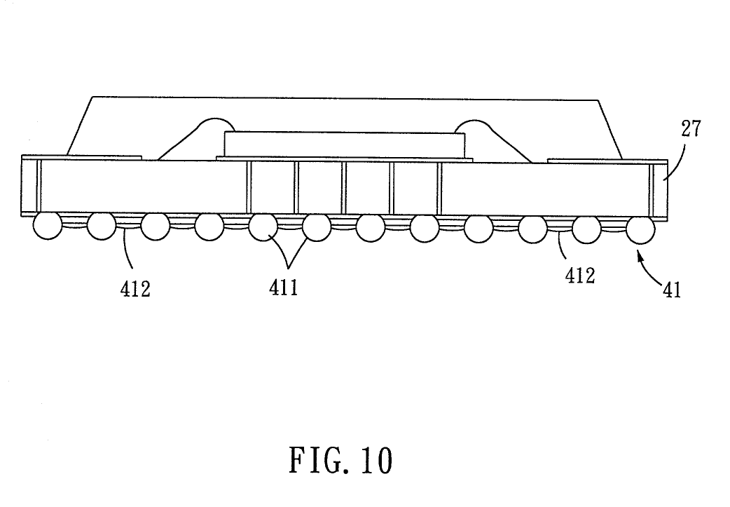

With further reference to FIG. 10, a process for producing an electronic device that uses the solder sheet according to this invention comprises the steps of:

preparing a substrate 27 with circuits thereon;

attaching the molded solder sheet 41 to the substrate 27;

separating the frame 413, the connecting portions 414, and the links 412 from the solder bumps 411 of the molded solder sheet 41 by peeling; and

welding the solder bumps 411 onto the substrate 27. The solder bumps 411 retaining on the substrate 27 can thus serve as contact terminals for the circuits on the substrate 27.

The process according to this invention can produce a solder sheet 41 having solder bumps 411 with a configuration identical to each other. Therefore, the aforesaid drawbacks of the prior art can be overcome, and the production yield of electronic devices can be enhanced.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A process for manufacturing a solder sheet with a bump grid array, said process comprising the steps of:
preparing a sheet of solder material;
preparing a mold which has two mold halves, each of said mold halves being formed with an array of first recesses, at least one of said mold halves being further formed with a plurality of second recesses interconnecting adjacent pairs of said first recesses, each of said first recesses having a depth deeper than that of said second recesses, said first recesses of one of said mold halves registering with said first recesses of the other of said mold halves such that said first and second recesses of said mold halves cooperatively form a mold cavity when said mold halves are brought toward each other to close said mold; and
disposing said sheet between said mold halves, and molding said sheet into a shape defined by said mold cavity.

2. The process as claimed in claim 1, wherein each of said mold halves is further formed with a frame recess surrounding outermost ones of said first recesses of said array.

3. The process as claimed in claim 1, wherein each of said second recesses increases gradually in depth from an adjacent connected one of said first recesses to a center thereof.

4. The process as claimed in claim 1, wherein each of said first recesses is semi-spherical in shape.

5. The process as claimed in claim 1, wherein each of said first recesses is rectangular in shape.

6. The process as claimed in claim 1, wherein said solder material is tin.

7. A solder sheet, comprising a grid array of solder bumps and a plurality of links interconnecting said solder bumps and integrally formed with said solder bumps from a solder material by a molding process, each of said links having a thickness smaller than those of said solder bumps.

8. The solder sheet as claimed in claim 7, further comprising a plurality of connecting portions connected to and extending between adjacent ones of said solder bumps and said links.

9. The solder sheet as claimed in claim 8, further comprising a frame surrounding outermost ones of said solder bumps of said grid array, and connected to outermost ones of said connecting portions.

10. The solder sheet as claimed in claim 7, wherein each of said links has a thickness profile which increases gradually from an adjacent connected one of said solder bumps to a center thereof.

11. The solder sheet as claimed inclaim7, wherein each of said solder bumps is spherical in shape.

12. The solder sheet as claimed in claim 7, wherein each of said solder bumps is rectangular in shape.

13. The solder sheet as claimed in claim 7, wherein said solder material is tin.

14. A process for producing an electronic device, comprising the steps of:
preparing a sheet of solder material;
preparing a mold which has two mold halves, each of said mold halves being formed with an array of first recesses, and a frame recess surrounding outermost ones of said first recesses of said array, at least one of said mold halves being further formed with a plurality of second recesses interconnecting adjacent pairs of said first recesses, each of said first recesses having a depth deeper than that of said second recesses, said first recesses of one of said mold halves registering with said first recesses of the other of said mold halves such that said first and second recesses of said mold halves cooperatively form a mold cavity when said mold halves are brought toward each other to close said mold;
disposing said sheet between said mold halves, and molding said sheet into a shape defined by said mold cavity so as to produce a molded solder sheet, which includes a grid array of solder bumps, a plurality of links interconnecting said solder bumps, a plurality of connecting portions connected to and extending between adjacent ones of said solder bumps and said links, and a frame surrounding outermost ones of said solder bumps of said grid array and connected to outermost ones of said connecting portions, each of said links having a thickness smaller than those of said solder bumps;
preparing a substrate with circuits thereon;
attaching said molded solder sheet to said substrate;
separating said frame, said links, and said connecting portions from said solder bumps by peeling; and
welding said solder bumps onto said substrate;
whereby said solder bumps serve as contact terminals for the circuits on said substrate.
